(19) United States
(12) Patent Application Publication
(10) Pub. No.: US 2020/0100193 A1
(43) Pub. Date: Mar. 26, 2020

(54) METHOD AND APPARATUS FOR TRIGGERING POWER HEADROOM REPORTS

(71) Applicant: FG Innovation Company Limited, Tuen Mun (HK)

(72) Inventors: YU-HSIN CHENG, Hsinchu (TW); CHIE-MING CHOU, Hsinchu (TW)

(21) Appl. No.: 16/582,088

(22) Filed: Sep. 25, 2019

Related U.S. Application Data
(60) Provisional application No. 62/735,967, filed on Sep. 25, 2018.

(51) Int. Cl. H04W 52/36; H04W 52/24; H04W 52/34; H04W 80/02; H04W 72/12

(52) U.S. Cl. CPC H04W 52/365; H04W 52/242; H04W 72/1268; H04W 80/02; H04W 52/346

(57) ABSTRACT

A method of wireless communication is provided. The method includes obtaining, by a user equipment (UE), information that indicates an association among multiple pathloss reference groups and multiple Transmission and Reception Points (TRPs), and determining, by the UE, whether a pathloss difference between a first pathloss estimated by a first pathloss reference Reference Signal (RS) and a second pathloss estimated by a second pathloss reference RS is larger than a Power Headroom Report (PHR) trigger threshold. The first pathloss reference RS and the second pathloss reference RS belong to a particular pathloss reference group of the pathloss reference groups. The method further includes triggering, by the UE, a first PHR when the pathloss difference is larger than the PHR trigger threshold.

### CROSS-REFERENCE TO RELATED APPLICATION(S)

The present application claims the benefit of and priority to a provisional U.S. Patent Application Ser. No. 62/735,967 filed on Sep. 25, 2018, entitled “Method and Apparatus for Power Headroom Report Enhancement.” with Attorney Docket No. US75058 (hereinafter referred to as “US75058 application”). The disclosure of the US75058 application is hereby incorporated fully by reference into the present application.

### FIELD

The present disclosure generally relates to wireless communications, and more particularly, to methods and apparatuses for triggering Power Headroom Reports (PHRs).

### BACKGROUND

Various efforts have been made to improve different aspects of wireless communications (e.g., data rate, latency, reliability, mobility, etc.) for the next generation (e.g., fifth generation (5G) New Radio (NR)) wireless communication systems. Among the new concepts in the next generation wireless communication systems, multiple Transmission and Reception Points (TRPs) may be vital to improve coverage, reliability, and capacity performance of the system. For example, in order to support the growth in data traffic in 5G and to enhance the coverage, the wireless devices may be expected to access networks composed of multiple TRPs.

PHRs may be used to indicate how much transmission power is left for a user equipment (UE) to use in addition to the power being used by a current transmission. However, the PHR triggering mechanism in current wireless communication systems may not be adequate for UEs performing multi-TRP operations.

Therefore, there is a need in the art for providing methods and apparatuses for triggering PHRs in the next generation wireless communication systems.

### SUMMARY

The present disclosure is directed to methods and apparatuses for triggering PHRs.

According to an aspect of the present disclosure, a User Equipment (UE) is provided. The UE includes one or more non-transitory computer-readable media having computer-executable instructions embodied thereon and at least one processor coupled to the one or more non-transitory computer-readable media. The at least one processor is configured to execute the computer-executable instructions to obtain information that indicates an association among multiple pathloss reference groups and multiple TRPs, and determine whether a pathloss difference between a first pathloss estimated by a first pathloss reference Reference Signal (RS) and a second pathloss estimated by a second pathloss reference RS is larger than a PHR trigger threshold. The first pathloss reference RS and the second pathloss reference RS belong to a particular pathloss reference group of the pathloss reference groups. The at least one processor is further configured to execute the computer-executable instructions to trigger a first PHR when the pathloss difference is larger than the PHR trigger threshold.

According to another aspect of the present disclosure, a method of wireless communications is provided. The method includes obtaining, by a UE, information that indicates an association among multiple pathloss reference groups and multiple TRPs, and determining, by the UE, whether a pathloss difference between a first pathloss estimated by a first pathloss reference RS and a second pathloss estimated by a second pathloss reference RS is larger than a PHR trigger threshold. The first pathloss reference RS and the second pathloss reference RS belong to a particular pathloss reference group of the pathloss reference groups. The method further includes triggering, by the UE, a first PHR when the pathloss difference is larger than the PHR trigger threshold.

### BRIEF DESCRIPTION OF THE DRAWINGS

Aspects of the present disclosure are best understood from the following detailed description when read with the accompanying figures. Various features are not drawn to scale. Dimensions of various features may be arbitrarily increased or reduced for clarity of discussion.

FIG. 1 is a schematic diagram illustrating a multi-TRP operation, in accordance with example implementations of the present disclosure.

FIG. 2 is a schematic diagram illustrating an operation of multiple active BWPs, in accordance with example implementations of the present disclosure.

FIG. 3 is a schematic diagram illustrating an example architecture of a base station (BS), in accordance with example implementations of the present disclosure.

FIG. 4 is a schematic diagram illustrating an example architecture of a UE, in accordance with example implementations of the present disclosure.

FIG. 5 shows an example multi-TRP system in accordance with example implementations of the present disclosure.

FIG. 6 is a schematic diagram illustrating a format of a MAC-CE, in accordance with example implementations of the present disclosure.

FIG. 7 is a schematic diagram illustrating a format of a MAC-CE, in accordance with example implementations of the present disclosure.

FIG. 8 is a schematic diagram illustrating an operation of multiple active BWPs, in accordance with example implementations of the present disclosure.

FIG. 9 is a schematic diagram illustrating a format of a MAC-CE, in accordance with example implementations of the present disclosure.

FIG. 10 is a schematic diagram illustrating a format of a MAC-CE, in accordance with example implementations of the present disclosure.

FIG. 11 is a schematic diagram illustrating a format of a MAC-CE, in accordance with example implementations of the present disclosure.

FIG. 12 is a flowchart of a method for triggering a PHR in a multi-TRP system, in accordance with example implementations of the present disclosure.

FIG. 13 is a schematic diagram illustrating multiple TRPs each being associated with a pathloss reference group, in accordance with example implementations of the present disclosure.

FIG. 14 is a block diagram illustrating a node for wireless communications, in accordance with various aspects of the present application.

### DETAILED DESCRIPTION

The following description contains specific information pertaining to example implementations in the present disclosure. The drawings in the present disclosure and their accompanying detailed description are directed to merely example implementations. However, the present disclosure is not limited to merely these example implementations. Other variations and implementations of the present disclosure will occur to those skilled in the art. Unless noted otherwise, like or corresponding elements among the figures may be indicated by like or corresponding reference numerals. Moreover, the drawings and illustrations in the present disclosure are generally not to scale and are not intended to correspond to actual relative dimensions.

For the purpose of consistency and ease of understanding, like features may be identified (although, in some examples, not shown) by the same numerals in the example figures. However, the features in different implementations may be differed in other respects, and thus shall not be narrowly confined to what is shown in the figures.

The description uses the phrases “in one implementation.” or “in some implementations.” which may each refer to one or more of the same or different implementations. The term “coupled” is defined as connected, whether directly or indirectly through intervening components, and is not necessarily limited to physical connections. The term “comprising,” when utilized, means “including, but not necessarily limited to”; it specifically indicates open-ended inclusion or membership in the so-described combination, group, series and the equivalent. The expression “at least one of A, B and C” or “at least one of the following: A. B and C” means “only A, or only B, or only C, or any combination of A. B and C.”

Additionally, for the purposes of explanation and non-limitation, specific details, such as functional entities, techniques, protocols, standard, and the like are set forth for providing an understanding of the described technology. In other examples, detailed description of well-known methods, technologies, systems, architectures, and the like are omitted so as not to obscure the description with unnecessary details.

Persons skilled in the art will immediately recognize that any network function(s) or algorithm(s) described in the present disclosure may be implemented by hardware, software or a combination of software and hardware. Described functions may correspond to modules which may be software, hardware, firmware, or any combination thereof. The software implementation may comprise computer executable instructions stored on computer readable medium such as memory or other type of storage devices. For example, one or more microprocessors or general-purpose computers with communication processing capability may be programmed with corresponding executable instructions and carry out the described network function(s) or algorithm(s). The microprocessors or general-purpose computers may be formed of Applications Specific Integrated Circuitry (ASIC), programmable logic arrays, and/or using one or more Digital Signal Processor (DSPs). Although some of the example implementations described in this specification are oriented to software installed and executing on computer hardware, nevertheless, alternative example implementations implemented as firmware or as hardware or combination of hardware and software are well within the scope of the present disclosure.

The computer readable medium includes but is not limited to Random Access Memory (RAM), Read Only Memory (ROM). Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication network architecture (e.g., a Long Term Evolution (LTE) system, an LTE-Advanced (LTE-A) system, an LTE-Advanced Pro system, or a 50 New Radio (NR) Radio Access Network (RAN)) typically includes at least one BS, at least one User Equipment (UE), and one or more optional network elements that provide connection towards a network. The UE communicates with the network (e.g., a Core Network (CN), an Evolved Packet Core (EPC) network, an Evolved Universal Terrestrial Radio Access Network (E-UTRAN), a 50 Core (5GC), or an internet), through a RAN established by one or more BSs.

It should be noted that, in the present application, a UE may include, but is not limited to, a mobile station, a mobile terminal or device, a user communication radio terminal. For example, a UE may be a portable radio equipment, which includes, but is not limited to, a mobile phone, a tablet, a wearable device, a sensor, a vehicle, or a Personal Digital Assistant (PDA) with wireless communication capability. The UE is configured to receive and transmit signals over an air interface to one or more cells in a radio access network.

A BS may be configured to provide communication services according to at least one of the following Radio Access Technologies (RATs): Worldwide Interoperability for Microwave Access (WiMAX), Global System for Mobile communications (GSM, often referred to as 2G), GSM Enhanced Data rates for GSM Evolution (EDGE) Radio Access Network (GERAN), General Packet Radio Service (GPRS), Universal Mobile Telecommunication System (UMTS, often referred to as 3G) based on basic Wideband-Code Division Multiple Access (W-CDMA), High-Speed Packet Access (HSPA), LTE LTE-A, eLTE (evolved LTE, e.g., LTE connected to 5GC), NR (often referred to as 5G), and/or LTE-A Pro. However, the scope of the present application should not be limited to the above-mentioned protocols.

A BS may include, but is not limited to, a node B (NB) as in the UMTS, an evolved Node B (eNB) as in the LTE or LTE-A, a Radio Network Controller (RNC) as in the UMTS, a Base Station Controller (BSC) as in the GSM/GERAN, a ng-eNB as in an Evolved Universal Terrestrial Radio Access (E-UTRA) BS in connection with the 5GC, a next generation Node B (gNB) as in the 5G-RAN, and any other apparatus capable of controlling radio communication and managing radio resources within a cell. The BS may serve one or more UEs through a radio interface.

The BS is operable to provide radio coverage to a specific geographical area using a plurality of cells forming the radio access network. The BS supports the operations of the cells. Each cell is operable to provide services to at least one UE within its radio coverage. More specifically, each cell (often referred to as a serving cell) provides services to serve one or more UEs within its radio coverage (e.g., each cell schedules the downlink and optionally (UL) resources to at least one UE within its radio coverage for downlink and optionally UL packet transmissions). The BS can communicate with one or more UEs in the radio communication system through the plurality of cells. A cell may allocate Sidelink (SL) resources for supporting Proximity Service (ProSe) or Vehicle to Everything (V2X) service. Each cell may have overlapped coverage areas with other cells.

As discussed above, the frame structure for NR is to support flexible configurations for accommodating various next generation (e.g., 5G) communication requirements, such as Enhanced Mobile Broadband (eMBB). Massive Machine Type Communication (mMTC), Ultra-Reliable and Low-Latency Communication (URLLC), while fulfilling high reliability, high data rate and low latency requirements. The Orthogonal Frequency-Division Multiplexing (OFDM) technology as agreed in the 3^{rd} Generation Partnership Project (3GPP) may serve as a baseline for NR waveform. The scalable OFDM numerology, such as the adaptive sub-carrier spacing, the channel bandwidth, and the Cyclic Prefix (CP) may also be used. Additionally, two coding schemes are considered for NR: (1) Low-Density Parity-Check (LDPC) code and (2) Polar Code. The coding scheme adaption may be configured based on the channel conditions and/or the service applications.

Moreover, it is also considered that in a transmission time interval TX of a single NR frame, a Downlink (DL) transmission data, a guard period, and a UL transmission data should at least be included, where the respective portions of the DL transmission data, the guard period, the UL transmission data should also be configurable, for example, based on the network dynamics of NR. In addition, SL resources may also be provided in an NR frame to support ProSe services or V2X services.

In addition, the terms “system” and “network” herein may be used interchangeably. The term “and/or” herein is only an association relationship for describing associated objects, and represents that three relationships may exist. For example, A and/or B may indicate that: A exists alone. A and B exist at the same time, or B exists alone. In addition, the character “/” herein generally represents that the former and latter associated objects are in an “or” relationship.

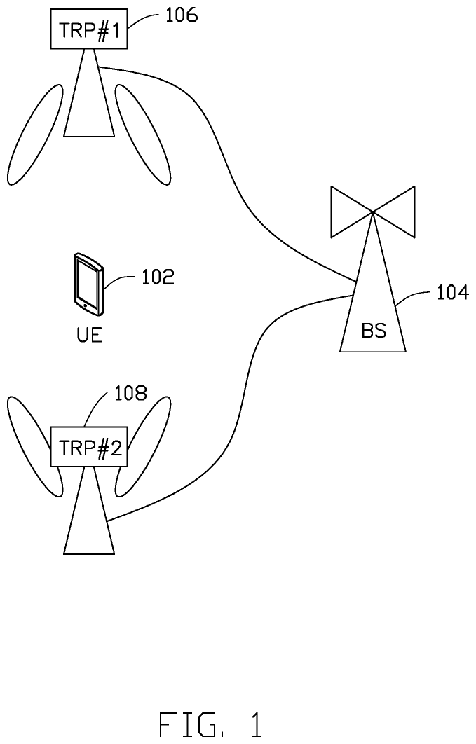

FIG. 1 is a schematic diagram illustrating a multi-TRP operation, in accordance with example implementations of the present disclosure. As shown in FIG. 1, a UE 102 may connect to a BS 104 through multiple TRPs (e.g., TRP #1 106 and TRP #2 108) separately. These TRPs may be macro-cells, small-cells, pico-cells, femto-cells, Remote Radio Heads (RRHs) or relay nodes, which may be deployed anywhere such as in the interior of a room, in/on a building, on top of a house or streetlamps. Each of the TRPs (e.g., TRP #1 106 and TRP #2 108) may have one or more antenna panels to provide directional beams towards the UE (e.g., UE 102). The antenna panels distributed on the TRPs may be jointly used in the transmissions to the UE, thereby forming a Multi-Input Multi-Output (MIMO) system.

Generally, as more antenna elements are formed in a single antenna panel, the cost and complexity of muting the antenna elements may become higher. Therefore, the MIMO system may have a lower hardware cost and a lower power consumption as compared to a single-panel antenna system. In addition, separating antenna panels by a proper distance may bring some benefits such as high multiplexing gain and low antennas correlation. Therefore, mechanisms for enabling and utilizing the benefits of the MIMO system (or multi-TRP system) may be needed.

Moreover, in the next generation wireless communication systems, the concept of Bandwidth Part (BWP) may be adopted to reduce power consumption at the UE end. A BWP may a contiguous set of Physical Resource Blocks (PRBs) on a given carrier. With the introduction of BWP, a UE does not need to monitor the entire bandwidth of a wideband carrier. In BWP operations, Bandwidth Adaptation (BA) mechanisms may be applied to data receptions or transmissions as expected by the UE. Different BWPs may be configured with different parameters (e.g., Sub-Carrier Spacing (SCS) value and Cyclic Prefix (CP) length) to meet different service requirements, such as eMBB and URLLC. For example, in order to achieve low latency data transmissions, services like URLLC may either demand a short Transmission Time Interval (TTI) that results in a higher SCS (e.g. 30 Kilohertz (KHz) or 60 KHz), or demand a mini-slot based scheduling. Therefore, in some of the present implementations, multiple BWPs (having different numerologies or different scheduling types (e.g., slots or mini-slots)) may support the Frequency Domain Multiplexing (FDM) of different services. In such a case, multiple BWPs may be activated at the same time, with each being associated with a particular service with a particular Quality of Service (QoS) requirement.

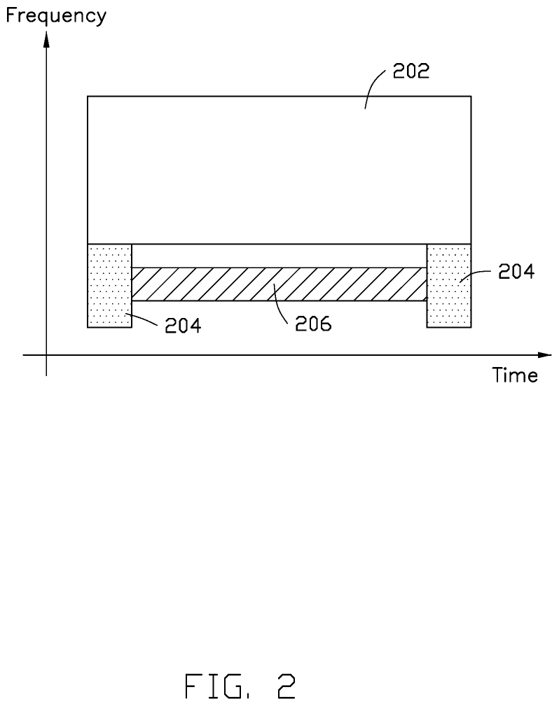

FIG. 2 is a schematic diagram illustrating an operation of multiple active BWPs, in accordance with example implementations of the present disclosure. As shown in FIG. 2, at least two of BWP #1 202 (with an SCS of 60 Kilo Hertz (KHz)), BWP #2 204 (with an SCS of 30 KHz) and BWP #3 206 (with an SCS of 30 KHz) may be activated at the same time. A UE may perform transmissions and/or receptions through one or more of the multiple active BWPs.

As described above, PHR procedures may be used to indicate how much transmission power is left for a UE to use in addition to the power being used by a current transmission. For example, a UE may transmit a PHR to inform a BS (e.g., a serving gNB) of a difference between a nominal UE maximum transmit power and an estimated UL transmit power (e.g., the transmit power for a UL-Shared Channel (UL-SCH) or a Sounding Reference Signal (SRS)) on an activated serving cell. In some of the present implementations, the PHR may further indicate a difference between a nominal UE maximum transmit power and an estimated transmit power of an UL-SCH (or a Physical Uplink Control Channel (PUCCH)) on a Special Cell (SPCell) (or a PUCCH Secondary Cell (SCell)).

In some cases, a PHR may be triggered if a PHR prohibit timer (e.g., phr-ProhibitTimer) has expired and/or a change in pathloss is larger than a threshold (e.g., phr-Tx-PowerFactorChange). The triggering of a PHR may be referred to as a PHR triggering operation which may include, but is not limited to, calculating a power headroom value, generating a PHR control unit, (re)starting a PHR prohibit timer, transmitting a PHR to a BS, etc. The activated serving cell(s) for a Medium Access Control (MAC) entity may be used as a reference to estimate the pathloss change between the last PHR transmission and the current new UL transmission in this MAC entity. However, such a mechanism may trigger unnecessary PHRs, when a UE is performing UL transmissions to different TRPs but the UE is incorrectly and/or mistakenly considered to be performing multiple transmissions to the same serving cell with different pathloss reference RSs. Because the pathloss difference between different TRPs may be large, the PHR triggered by the above-described mechanism (e.g., determining whether the pathloss difference between different TRPs is larger than a threshold (e.g., phr-TX-PowerFactorChange)) may be unnecessary.

In addition, the activation of an SCell of a MAC entity (having a configured UL grant) may also trigger a PHR. However, different active UL BWPs may have different channel conditions and different pathloss values in one cell. Hence, some implementations of the present disclosure may provide an improved PHR triggering mechanism for a multi-active-BWP system.

PHR for Multi-TRP Operation

In multi-TRP operations, a UE may perform transmissions and receptions (upon one cell or one BWP) with multiple TRPs. The UE may be explicitly or implicitly informed by the BS of the TRP that performs transmissions or receptions with the UE. In some of the present implementations, the explicit indicator may be a TRP index. In some of the present implementations, the implicit indicator may be an TRP-to-RS mapping table. With the TRP-to-RS mapping table, the UE may identify the mapping relationship between different RSs and TRPs by referring to Transmission Configuration Indicator (TCI) states or spatial domain filter information (e.g., Reference Signal (RS) Identities (IDs)) for DL or UL operations.

In some of the present implementations, a mechanism for triggering one or more PHRs in a multi-TRP system is provided. In addition, when a UE triggers a PHR, it is assumed that this UE has enough UL resources to trigger the PHR and the PHR prohibit timer has expired. In addition, the format of a PHR may be type 1, type 2, type 3, or any other enhanced PHR format (e.g., any PHR format defined in a future release of the 3GPP specifications).

In some of the present implementations, each TRP may be associated with a pathloss reference group that includes at least one pathloss reference RS. The UE may be configured with the pathloss reference groups by a BS through Radio Resource Control (RRC) signaling. The UE may trigger a PHR when the UE detects that a pathloss difference of the pathloss reference RS(s) is larger than a PHR trigger threshold. In some of the present implementations, the pathloss difference may be a difference between a first pathoss that is measured (at the last PHR transmission) through a first pathloss reference RS and a second pathloss that is measured (at the current time) through a second pathloss reference RS. The first pathloss reference RS may be the same as, or different than, the second RS. In some of the present implementations, the first pathloss reference RS and the second pathloss reference RS may be two RSs used in the last PHR transmission and current PHR transmission, respectively. The first pathloss reference RS and the second pathloss reference RS may belong to the same pathloss reference group. In some of the present implementations, if a UE is configured with multiple pathloss reference groups, the PHR for each pathloss reference group may be triggered independently.

In some of the present implementations, each pathloss reference group may include at least one RS index. For those RSs having RS indices that belong to different pathloss reference groups, the UE may consider that those RSs may be transmitted by different TRPs.

In some of the present implementations a pathloss reference group may include at least one TRP index. For those TRPs having TRP indices that belong to the same pathloss reference group, the UE may consider that the those TRPs may have the same (or similar) pathloss. In such a case, a PHR may be triggered when a pathloss difference (between the pathloss values monitored from two or more TRPs belonging to the same group) is larger than a PHR trigger threshold. In some of such implementations, the UE may associate each pathloss reference RS with a pathloss reference group based on an RS index(s) configured in a particular configuration for pathloss calculation. Such a particular configuration may include at least one of a Physical Uplink Shared Channel (PUSCH) configuration, a PUCCH configuration, an SRS configuration, and a TRP-to-RS mapping table/configuration. In some of the present implementations, the TRP-to-RS mapping table/configuration may be used to help a UE to determine the source or destination of each RS. The TRP-to-RS mapping table/configuration may be contained in at least one of Downlink Control Information (DCI), a MAC-Control Element (MAC-CE), and RRC signaling.

In some of the present implementations, a UE may not be provided with an explicit indicator of a pathloss reference group. Instead, the UE may identify the relationship between the TRPs and the pathloss reference groups based on an implicit method (e.g., according to a TRP-to-RS mapping table/configuration). For example, the UE may know that a TRP #1 is associated with an RS #1 based on the TRP-to-RS mapping table, and identify that the TRP #1 is associated with a pathloss reference group #1 if the RS #1 is included in the pathloss reference group #1.

In some of the present implementations, the pathloss reference group may include at least one Demodulation Reference Signal (DMRS) port index or at least one DMRS port group index. A UE may consider that the RSs that are associated with different DMRS ports or DMRS port groups may belong to different pathloss reference groups.

In some of the present implementations, if a UE is not provided with an explicit indicator of a pathoss reference group, the UE may determine the relationship between the TRPs and RSs according to the DMRS port group. For example, different DMRS port groups may be associated with different RSs. A UE may consider that the RSs associated with different DMRS port groups may be transmitted by different TRPs.

In some of the present implementations, the UE may trigger a PHR when the UE is configured with a new TRP (e.g., a TRP has not been configured to the UE through a MAC-CE or RRC signaling) by the BS. For example, the UE may trigger the PHR when the UE successfully receives a configuration of a new TRP.

In some of the present implementations, the configuration of the new TRP may be a modification or an addition of an existing TRP-to-RS mapping table (or a DMRS port group configuration).

In some of the present implementations, the configuration of the new TRP may be a MAC-CE indicating that a transmission or a reception of a physical channel (e.g., a DL control/data channel or a UL control/data channel) is to be performed by the new TRP. For example, a UE may identify a source TRP of a DL channel based on a TCI state activation indicator contained in a MAC-CE. For example, the UE may identify a destination TRP of a UL channel based on the spatial domain filter information of a PUCCH and an SRS activation indicator contained in a MAC-CE. In some of the present implementations, a BS may apply a multiple stage indication for the content of the DCI. To be more specific, the BS may use RRC signaling to adjust the content of the MAC-CE. For example, the BS may first configure a list of RSs (e.g., with a Quasi-Co-Located (QCL) type of Type-D for describing the spatial domain filter parameters) to the UE through RRC signaling, and then indicate one or more RSs contained in the list through a MAC-CE.

In some of the present implementations, the configuration of the new TRP may be an RRC configuration indicating that a transmission or a reception of a physical channel (e.g., a DL control/data channel or a UL control/data channel) is to be performed by the new TRP. For example, the UE may be configured with the new TRP when the UE receives a configuration of the new TRP through RRC signaling from the BS. The configuration of the new TRP may include at least one of a first TCI state for a Physical Downlink Control Channel (PDCCH) associated with the new TRP, a second TCI state for a Physical Downlink Shared Channel (PDSCH) associated with the new TRP, a Channel State Information Reference Signal (CSI-RS) configuration associated with first spatial domain filter information for the new TRP, an SRS configuration associated with second spatial domain filter information for the new TRP, and a Physical Uplink Control Channel (PUCCH) configuration associated with the second spatial domain filter information for the new TRP. The UE may identify a source TRP of a DL channel based on a TCI state activation in an RRC configuration for a data channel or a control channel. For example, for DL operations, the UE may obtain the TRP information of a DL channel based on at least one of a TRP-to-RS mapping table/configuration, a TCI state configuration, and a DMRS port group configuration. For UL operations, the UE may obtain the TRP information of a UL channel based on at least one of a TRP-to-RS mapping table/configuration, a TCI state, an SRS configuration, and a PUCCH configuration.

In some of the present implementations, a PHR may be triggered when a UE successfully receives an activation indicator of a new TRP. For example, the activation indicator may include at least one of a first TCI state for a PDCCH associated with the new TRP, a second TCI state for a PDSCH associated with the new TRP, a Sounding Reference Signal Resource Index (SRI) of a PUSCH associated with the new TRP, a CSI-RS associated with the new TRP, and a Synchronization Signal Block (SSB) associated with the new TRP. In some of such implementations, the new TRP may be referred to as a TRP that is different from the latest TRP indicated by the DCI for reception/transmission. In some of the present implementations, the activation indicator of a new TRP may be contained in the DCI to indicate that a transmission or reception of a physical channel is to be performed by the new TRP. For example, the UE may identify a source TRP of a DL channel based on a TCI state, a DMRS port group, or a TRP index contained in the DL DCI. The UE may also identify a destination TRP of a UL channel based on an SRI, a TCI state, a DMRS port group, or a TRP index contained in UL DCI. In some of the present implementations, each TRP index may be represented by (or be associated with) a Control Resource Set (CORESET) index/configuration. For example, a TRP index may be a specific index associated to a CORESET configuration. Different CORESET indices/configurations may be directed to different TRP indices. In some other implementations, each TRP index may be represented by (or be associated with) a panel (e.g., an antenna panel) ID. In such cases, different panel IDs may be directed to different TRP indices. It is worthy to mention that the BS may apply a multiple stage indication for the content of the DCI. To be more specific, the BS may use RRC signaling, or both of RRC signaling and MAC-CE signaling, to adjust the content of the DCI. For example, the RRC signaling may contain a list of candidates (e.g., a list of RSs), and the BS may use the DCI to indicate one of the candidates contained in the list. In another example, if the RRC signaling contains a list of candidates, the BS may use a MAC-CE to indicate a subset of the candidates, and select one candidate from the subset through DCI signaling.

In some of the present implementations, each pathloss reference group may be associated with a PHR prohibit timer. Each of the PHR prohibit timers may be operated independently of one another. In such a case, the number of PHR configurations (e.g., including a PHR trigger threshold and/or a PHR prohibit timer) in a cell group may be the same as the number of the pathloss reference groups. In some of the present implementations, each PHR configuration may map to (or be associated with) a pathloss reference group according to the order of the PHR configurations, or according to the pathloss-reference-group-related information (e.g., TRP indices. RS indices, or DMRS port group indices) contained in the PHR configurations.

In some of the present implementations, each pathloss reference group may be associated with a PHR configuration that includes a PHR trigger threshold and/or a PHR prohibit timer. For example, different pathloss reference groups may be associated with different PHR configurations, and each PHR configuration may be configured independently. In some of such implementations, a UE may be configured with multiple PHR configurations, with each PHR configuration containing a PHR configuration index. The pathloss reference group configurations may be associated with the PHR configurations according to the PHR configuration indices.

In some of the present implementations, a PHR triggering operation may be canceled when a UE is configured with a new TRP (or the TRP information is modified) through a MAC-CE or RRC signaling. The PHR triggering operation may include, for example, calculating a power headroom value, generating a PHR control unit, (re)starting a PHR prohibit timer, transmitting a PHR to the BS, etc.

In some of the present implementations, the association between a pathloss reference group and a source/destination TRP of a DL/UL channel may be configured by the BS through MAC-CE signaling, DCI signaling or RRC signaling.

In some of the present implementations, the content and/or format of a MAC-CE containing at least one PHR (which may be referred to as a PHR MAC-CE) may be modified to adapt to the multi-TRP system. The PHR MAC-CE may be a single-entry MAC-CE, a multi-entry MAC-CE, or any other MAC-CE suitable for carrying a PHR(s). In some of the present implementations, the PHR MAC-CE may include at least one of a pathloss reference group index of a pathloss reference group, a pathloss reference index of a pathloss reference RS, and a TRP index. In some other of the present implementations, the PHR MAC-CE may include a bitmap that represents at least one of (1) a pathloss reference group index of a pathloss reference group, (2) a pathloss reference index of a pathloss reference RS, and (3) a TRP index. Examples of the PHR MAC-CE are described below.

In some of the present implementations, the PHR MAC-CE may contain a field to indicate the index of a pathloss reference group.

In some of the present implementations, at least part of the reserved bit field of the PHR MAC-CE may be used to indicate the index of a pathloss reference group.

In some of the present implementations, the PHR MAC-CE may contain a field to indicate the index of a pathloss reference RS.

In some of the present implementations, at least part of the reserved bit field of the PHR MAC-CE may be used to indicate the index of a pathloss reference RS.

In some of the present implementations, the PHR MAC-CE may contain a field to indicate the index of a TRP.

In some of the present implementations, at least part of the reserved bit field of the PHR MAC-CE may be used to indicate the index of a TRP.

In some of the present implementations, the PHR MAC-CE may contain a field to indicate the index of a DMRS port group.

In some of the present implementations, the reserved bit field of the PHR MAC-CE may indicate the index of a DMRS port group.

In some of the present implementations, the PHR MAC-CE may contain a pathloss reference group bitmap. Each active bit (e.g., “1”) in the pathloss reference group bitmap may map to a pathloss reference group. In addition, the number of bits in the pathloss reference group bitmap may be the same with the number of the pathloss reference groups configured by the BS. One or more PHRs contained in the PHR MAC-CE may correspond to the pathloss reference groups mapping to the active bit(s) of the pathloss reference group bitmap.

In some of the present implementations, at least part of the reserved bit field of the PHR MAC-CE may include the pathloss reference group bitmap.

In some of the present implementations, the PHR MAC-CE may contain a new field used as a pathloss reference bitmap. Each active bit (e.g., “I”) in the pathloss reference bitmap may map to a pathloss reference RS. In addition, the number of bits in the pathloss reference bitmap may be the same with the number of the pathloss reference RSs configured by the BS, and the PHR(s) contained in the PHR MAC-CE may correspond to the pathloss reference RS(s) mapping to the active bit(s) in the pathloss reference bitmap.

In some of the present implementations, the reserved bit field of the PHR MAC-CE may be used as the bitmap of pathloss reference.

In some of the present implementations, the PHR MAC-CE may contain a new field used as a TRP bitmap. Each active bit (e.g., “1”) in the TRP bitmap may map to a TRP. In addition, the number of bits in the TRP bitmap may be the same as the number of the TRPs configured by the BS, and the PHR(s) contained in the PHR MAC-CE may correspond to the TRP(s) mapped to the active bit(s) in the TRP bitmap.

In some of the present implementations, the reserved bit field of the PHR MAC-CE may be used as the TRP bitmap.

In some of the present implementations, the PHR MAC-CE may contain a new field which is used as a DMRS port group bitmap. Each active bit (e.g., “1”) in the DMRS port group bitmap may map to a DMRS port group. For example, the number of bits in the DMRS port group bitmap may be the same with the number of the DMRS port groups configured by a BS, and the PHR(s) contained in the PHR MAC-CE may correspond to the DMRS port group(s) mapping to the active bit(s) in the DMRS port group bitmap.

In some of the present implementations, the reserved bit field of the PHR MAC-CE may be used as the bitmap of DMRS port group.

In some of the present implementations, whether a UE uses the reserved bit field of a PHR MAC-CE to indicate different pathloss reference groups (or other information of the pathloss reference groups (e.g., TRP indices, DMRS port group indices or RS indices)) for a serving cell may be based on the number of pathloss reference groups (e.g., TRP indices. DMRS port group indices or RS indices) activated or configured in the serving cell. For example, if a BS configures or activates two (or more) TRPs to a UE, the UE may use the reserved bit in the PHR MAC-CE to indicate the pathloss reference group information.

In some of the present implementations, a PHR applied in the multi-TRP system may have a different Logical Channel Identity (LCID) from a PHR applied in the single-TRP system (or a PHR defined in the NR Release-15).

PHR for Multi-Active-BWP Operation

In a multi-active-BWP operation, a UE may perform transmissions and receptions through multiple active BWPs within one cell. The time domain resource allocation of the active UL/DL BWPs may overlap with each other in at least one OFDM symbol. The multi-active-BWP operation may be indicated by DCI, MAC-CE or RRC signaling.

In some of the present implementations, a method for triggering one or more PHRs in a multi-active-BWP system is provided. For example, a PHR may be triggered when a pathloss difference between a first pathloss measured at the last PHR transmission and a second pathloss measured at a current time is larger than a PHR trigger threshold. The first pathloss may be measured by a first pathloss reference RS that is associated with a first UL BWP, and the second pathloss may be measured by a second pathloss reference RS that is associated with a second UL BWP. The first DL BWP and the second DL BWP may be associated with the same DL BWP. In some of the present implementations, the first pathloss reference RS may be the same as, or different than, the second pathloss reference RS. For example, the first pathloss reference and the second pathloss reference may be different RSs used in the last PHR transmission and current PHR transmission, respectively. In some of the present implementations, if a UE is configured to perform UL transmissions via multiple UL active BWPs at the same time, the PHR for each active UL BWP may be triggered independently.

In some of the present implementations, a PHR may be triggered when a UE is configured with a new UL BWP (e.g., a UL BWP having a UL BWP ID that has not been configured to the UE though a MAC-CE or RRC signaling). For example, the UE may trigger a PHR when the UE successfully receives a configuration of a new UL BWP.

In some of the present implementations, the configuration of the new UL BWP may be a modification (e.g., an addition) of a configured UL BWP.

In some of the present implementations, a PHR may be triggered when a UE successfully receives an activation indicator of a new UL BWP. Such an activation indicator may be contained in the DCI that indicates a transmission of a UL data/control channel on the new UL BWP. For example, a UE may determine a UL BWP according to a UL BWP index contained in the UL DCI, or determine a UL BWP according to a UL BWP associated with a PUCCH resource that is indicated by a PUCCH resource indicator of the DCI. In some of the present implementations, the association between the PUCCH resource (for transmitting the Uplink Control Information (UCI)) and the UL BWP may be determined based on the BWP index(s). For example, the UCI triggered on a DL BWP may be transmitted in the associated UL BWP based on the linkage configured by a BWP configuration.

In some of the present implementations, each active UL BWP (overlapping each other in the time domain) may be associated with a PHR prohibit timer. The PHR prohibit timer of each active UL BWP may be configured independently of one another. In addition, the number of the PHR configurations for one cell group may be the same as the number of the UL BWPs, and each PHR configuration may map to a UL BWP. For example, the mapping relationship between the PHR configurations and the UL BWPs may be determined based on the order of the PHR configuration indices and the UL BWP indices. As shown in Table 1, four PHR configuration indices #1, #2, #4, and #7 may be mapped to UL BWP indices #2, #3, #5 and #6, respectively, based on an ascending order.

TABLE 1

| PHR configuration index | UL BWP index |
|---|---|
| #1 | #2 |
| #2 | #3 |
| #4 | #5 |
| #7 | #6 |

In some of the present implementations, each UL BWP may be associated with a PHR configuration. The PHR configuration of each UL BWP may be configured independently of one another. In addition, each PHR configuration may contain a PHR configuration index. Each UL BWP configuration may be associated with one PHR configuration according to the PHR configuration index. For example, a UL BWP #1 may be associated with a PHR configuration that contains a PHR configuration index #1, a UL BWP #2 may be associated with another PHR configuration that contains a PHR configuration index #2, and so on.

In some of the present implementations, a PHR triggering operation may be canceled when the UE is configured with a new UL BWP, or when a UL BWP configuration is modified through a MAC-CE or RRC signaling.

Some of the present implementations provide improved PHR MAC-CEs that are adapted to the multi-active-BWP system. The PHR MAC-CE may be a single-entry MAC-CE, a multi-entry MAC-CE, or any other PHR MAC-CE defined in the 3GPP specifications.

In some of the present implementations, the PHR MAC-CE may contain a field to indicate the index of a UL BWP.

In some of the present implementations, the reserved bit field of the PHR MAC-CE may indicate the index of a UL BWP.

In some of the present implementations, the PHR MAC-CE may contain a UL BWP bitmap. Each active bit in the UL BWP bitmap may map to a UL BWP. In addition, the number of bits in the UL BWP bitmap may be the same as the number of the UL BWPs configured by the BS. One or more PHRs contained in the PHR MAC-CE may correspond to the UL BWP(s) mapping to the active bit(s) in the UL BWP bitmap.

In some of the present implementations, the reserved bit field of the PHR MAC-CE may include the UL BWP bitmap.

In some of the present implementations, whether a UE uses the reserved bit field of a PHR MAC-CE to indicate the UL BWP index for a serving cell may be determined based on the number of UL BWPs activated or configured in the serving cell. For example, if a BS configures or activates two or more UL BWPs to a UE, the UE may use the reserved bit in the PHR MAC-CE to indicate the pathloss reference group information.

In some of the present implementations, the PHR MAC-CE may include an indicator (e.g., a one-bit indicator) to indicate that a specific field of the PHR MAC-CE is either used to represent the UL BWP index(ices) or used to represent the serving cell index(ices). For example, if such an indicator is active (e.g., being set to “I”), the serving cell index field of the PHR MAC-CE may be re-interpreted as a UL BWP index for a Primary Cell (PCell).

In some of the present implementations, the BS may configure the UE to report the PHRs for all of the UL BWPs in the PCell. In some other of the present implementations, the UE may decide, by itself, whether to report the PHRs for all of the UL BWP according to the number of active serving cells. For example, if the UE operates in the PCell only, the UE may use a multi-entry PHR MAC-CE to report the PHRs for all of the UL BWP in the PCell.

In some of the present implementations, the PHR applied in the multi-active-BWP system may have a different LCID from the PHR applied in the single-active-BWP system (or a PHR for the NR Release-15).

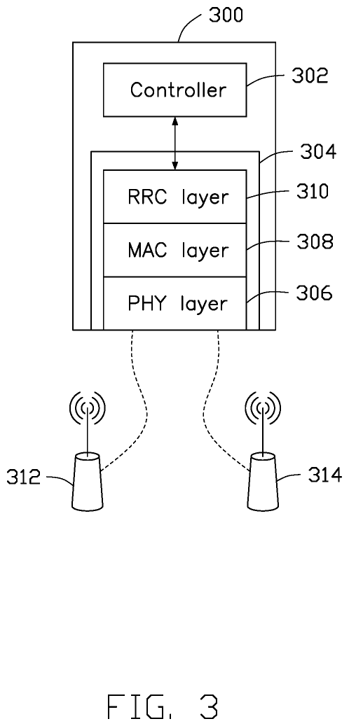

FIG. 3 is a schematic diagram illustrating an example architecture of a BS, in accordance with example implementations of the present disclosure. As shown in FIG. 3, a BS 300 may include a controller 302 and a protocol stack 304 that contains a number of protocol layers (e.g., a Physical (PHY) layer 306, a MAC layer 308, and an RRC layer 310). The controller 302 may include a processor and/or a microcontroller for controlling and coordinating the activities of the various protocol layers of the protocol stack 304. In the example implementation, the PHY layer 306 may be coupled to multiple TRPs (e.g., TRPs 312 and 314), and these TRPs 312 and 314 may share with the same higher layer components.

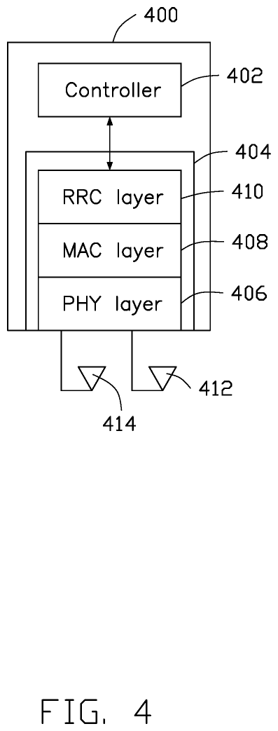

FIG. 4 is a schematic diagram illustrating an example architecture of a UE, in accordance with example implementations of the present disclosure. As shown in FIG. 4, a UE 400 may include a controller 402 and a protocol stack 404 that contains a number of protocol layers (e.g., a PHY layer 406, a MAC layer 408, and an RRC layer 410). The PHY layer 406 may be coupled to a Transmit (TX) circuit 412 and a Receive (RX) circuit 414 for transmitting and receiving signals. The controller 402 may include a processor and/or a microcontroller for controlling and coordinating the activities of the various protocol layers of the protocol stack 404. For example, the controller 402 may set and coordinate the PHY layer 406, the MAC layer 408, and the RRC layer 410 based on the received signals from the RX circuit 414. The controller 402 may further set one or more transmission parameters for the TX circuit 412 based on the input obtained from the RX circuit 414.

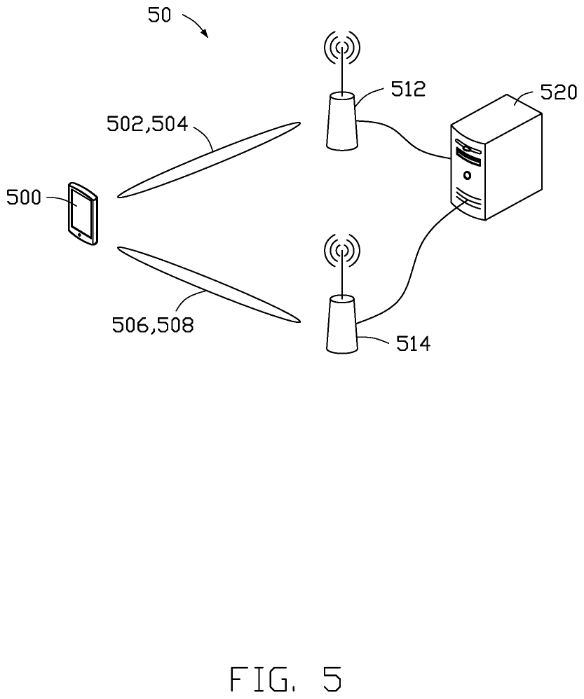

FIG. 5 shows an example multi-TRP system in accordance with example implementations of the present disclosure. As shown in FIG. 5, a multi-TRP system 50 includes a UE 500, a BS 520, and two TRPs 512 and 514 coupled to the BS 520. The UE 500 may correspond (but not limited) to the UE 400 illustrated in FIG. 4. The BS 520, the TRPs 512, and 514 may correspond (but not limited) to the BS 300, the TRPs 312 and 314 illustrated in FIG. 3, respectively. It should be noted that even though two TRPs are included in the example multi-TRP system, any number of TRPs may be coupled to the BS in some other implementations of the present disclosure.

In the example implementation, the BS 520 may transmit a signal 502 and an RS 504 (e.g., a pathloss reference RS) to the UE 500 via the TRP 512, and transmit a signal 506 and an RS 508 (e.g., a pathloss reference RS) to the UE 500 via the TRP 514. The signal 502 or 506 may be a control signal (e.g., DCI) or data (e.g., Transport Blocks (TBs)) transmitted in a PDSCH. Each of the TRP 512 and the TRP 514 may be associated with a pathloss reference group. For example, the TRP 512 may be associated with a pathloss reference group #1, and the TRP 514 may be associated with a pathloss reference group #2. Each pathloss reference group may include one or more pathloss reference RSs. For example, the pathloss reference group #1 may include the RS 504, and the pathloss reference group #2 may include the RS 508. The mapping relationship between the pathloss reference groups and the RSs may be defined in a pathloss reference group configuration that is contained in an RRC configuration. In some of the present implementations, the pathloss reference RS(s) included in a pathloss reference group may be associated with spatial domain filter information that is configured for a CORESET indicated by a PDCCH configuration. In some of the present implementations, the pathloss reference RS(s) included in a pathloss reference group may be associated with a DMRS port group. In some of the present implementations, the pathloss reference RS(s) included in a pathloss reference group may be selected from an intersection of a first RS set and a second RS set. The first RS set may include all RSs associated with a TRP corresponding to the pathloss reference group, and the second RS set may include multiple configured pathloss reference RSs of a PUSCH, a PUCCH, or an SRS.

In some of the present implementations, the signal 502 and the RS 504 may be transmitted in a slot # n. and the signal 506 and the RS 508 may be transmitted in another slot # n+k (e.g., k>0). The UE 500 may receive the signals 502 and 506 and the RSs 504 and 508 through its RX circuit and decode the PDCCHs containing the DCI for the UL transmissions through the PHY layer. In addition, the PDCCH that is transmitted via the signal 502 may be used to schedule a UL transmission that is associated with the RS 504, and the PDCCH that is transmitted via the signal 506 may be used to schedule a UL transmission that is associated with the RS 508. Because the RS 504 and the RS 508 may belong to different pathloss reference groups, the MAC layer of the UE 500 may not trigger a PHR for a UL grant (contained in the signal 506) even when the pathloss difference between the pathloss measured by the RS 504 and the pathloss measured by the RS 508 is larger than a PHR trigger threshold (e.g., contained in an RRC configuration), and when the UL grant in the signal 506 indicates that the UL resource for transmitting the PHR is enough. In some of the present implementations, to avoid reporting PHRs too frequently, the above-described PHR trigger threshold may be configured with a specific value when the UE is communicating with multiple TRPs. For example, the PHR trigger threshold may be configured by the BS with a normal value (e.g., 1 dB or 2 dB) when the UE is in a single-TRP system, and may be configured with a specific value (e.g., infinity or a value higher than the normal value, such as 5 dB) when the UE is in a multi-TRP system.

In some of the present implementations, the UE 500 may know that the RS 504 and the RS 508 belong to different pathloss reference groups based on a TRP-to-RS mapping table.

In some of the present implementations, the UE 500 may know that the RS 504 and the RS 508 belong to different pathloss reference groups because the UE 500 detects that the RS 504 and the RS 508 are associated with different DMRS port groups or different PHR configuration indices.

In some of the present implementations, the MAC layer of the UE 500 may obtain a PHR configuration for each pathloss reference group from a higher layer (e.g., from the RRC layer of the UE 500). The UE 500 may then determine whether the RS 504 and the RS 508 belong to different pathloss reference groups based on the PHR configuration indices for the pathloss reference groups.

In some of the present implementations, the UE 500 may be configured with multiple PHR configurations in a cell group. For example, these configured PHR configurations may include a PHR configuration #1 and a PHR configuration #2. The PHR configuration #1 may be associated with a pathloss reference group #1 that includes the RS 504, and the PHR configuration #2 may be associated with a pathloss reference group #2 that includes the RS 508. In such a case, the PHR configuration #1 may include an index of the pathloss reference group #1 that includes the RS 504, and the PHR configuration #2 may include an index of the pathloss reference group #2 that includes the RS 508.

In some of the present implementations, the UE 500 may cancel the PHR triggering operation for a specific TRP when certain condition(s) is satisfied. For example, the UE 500 may cancel triggering a PHR #1 for the TRP 514 but trigger a PHR #2 for the TRP 512, when the available UL resource is not enough to transmit both of the PHR #1 and the PHR #2, and when the pathloss difference measured for the TRP 512 is larger than that for the TRP 514.

In some of the present implementations, the UE 500 may trigger a PHR when the UE 500 receives a MAC-CE or RRC signaling from the BS 520 via the signal 502. Such a MAC-CE or RRC signaling may indicate to the UE 500 to initiate a UL/DL transmission/reception to a TRP that is different from the TRP that is currently (or latest) communicating with the UE 500.

In some of the present implementations, the MAC layer of a UE may be configured with several PHR prohibit timers, with each PHR prohibit timer corresponding to a TRP. For example, the MAC layer of the UE 500 may be configured with a PHR prohibit timer #1 and a PHR prohibit timer #2 for the TRP 512 and the TRP 514, respectively. When the MAC layer of the UE 500 receives a UL grant from the signal 502 (e.g., the UL grant may contain an SRI and/or other QCL information for a PUSCH that is associated with the RS 504), the controller of the UE 500 may not instruct the MAC layer of the UE 500 to trigger a PHR, if the PHR prohibit timer #1 and the PHR prohibit timer #2 have not expired. Conversely, if one or more of the PHR prohibit timers #1 and #2 have expired when the MAC layer of the UE 500 receives the UL grant, the controller of the UE 500 may instruct the MAC layer of the UE 500 to trigger one or more PHRs for the TRP(s) associated with the expired PHR prohibit timer(s). For example, the UE 500 may trigger a PHR for the TRP 514 based on a pathloss measured by the RS 508, if the MAC layer of the UE 500 receives the UL grant when the PHR prohibit timer #2 that is associated with the TRP 514 expires. In some of the present implementations, each PHR prohibit timer may be operated independently of one another. For example, the PHR prohibit timer #1 for the TRP 512 may be operated independently of the PHR prohibit timer #2 for the TRP 514. For example, the UE 500 may check only the PHR prohibit timer #2 if the RS is associated with the TRP 514. In such a case, the MAC layer of the UE 500 may be allowed to trigger a PHR for the TRP 514 even though the PHR prohibit timer #1 for the TRP 512 has not yet expired.

In some of the present implementations, when the UE 500 receives an RRC reconfiguration message from the BS 520 for modifying the TRP-to-RS mapping table (e.g., to change the mapping relationship between the RS 508 and the TRP 514), the UE 500 may cancel the PHR triggering operation for the TRP (e.g., the TRP 514) of which the TRP-to-RS mapping relationship is changed.

In some of the present implementations, the UE 500 may cancel the PHR triggering operation for a specific TRP when the UE 500 receives an RRC reconfiguration message for modifying the DMRS port group associated with the specific TRP.

In some of the present implementations, the UE 500 may cancel the PHR triggering operation for a specific TRP when the UE 500 receives an RRC reconfiguration message, or a MAC-CE, for modifying the pathloss reference group(s), and/or the pathloss reference RS(s), associated with the specific TRP.

In some of the present implementations, the controller of the UE 500 may instruct the MAC layer of the UE 500 to initiate the PHR triggering operation and transmit the PHR via a PHR MAC-CE to the BS 520. In some of such implementations, the PHR MAC-CE may include a field that contains one or more pathloss reference group indices to indicate the pathloss reference group(s) corresponding to the PHR contained in the PHR MAC-CE. The MAC layer of the UE 500 may calculate a power headroom value according to the pathloss measured by the pathloss reference RS of the pathloss reference group indicated by the pathloss reference group index in the PHR MAC-CE.

In some of the present implementations, the PHR MAC-CE may include a field that contains one or more pathloss reference RS indices to indicate the pathloss reference RS(s) corresponding to the PHR(s) contained in the PHR MAC-CE. The MAC layer of the UE 500 may calculate a power headroom value according to the pathloss measured by the pathloss reference RS associated with the pathloss reference RS index in the PHR MAC-CE.

In some of the present implementations, the PHR MAC-CE may include a field that contains one or more TRP indices to indicate the TRP(s) corresponding to the PHR(s) contained in the PHR MAC-CE. The MAC layer of the UE 500 may calculate a power headroom value according to the pathloss measured by the pathloss reference RS associated with the TRP index in the PHR MAC-CE.

In some of the present implementations, the PHR MAC-CE may include a field that contains one or more DMRS port group indices to indicate the DMRS port group index(s) corresponding to the PHR(s) contained in the PHR MAC-CE. The MAC layer of the UE 500 may calculate a power headroom value according to the pathloss measured by the pathloss reference RS associated with the indicated DMRS port group index.

In some of the present implementations, the PHR MAC-CE may include a field that contains one or more PHR configuration indices to indicate the PHR configuration(s) for the PHR(s) contained in the PHR MAC-CE.

In some of the present implementations, the PHR MAC-CE may include a field of a pathoss reference group bitmap to indicate the pathoss reference group(s) corresponding to the PHR(s) contained in the PHR MAC-CE. In an example implementation, if the pathloss reference group bitmap contains multiple active bits (e.g., “1”), the UE 500 may calculate and report multiple PHRs corresponding to the pathloss reference groups based on the order of the pathloss reference groups and the active bits in the pathloss reference group bitmap.

In some of the present implementations, the PHR MAC-CE may include a field of a TRP bitmap to indicate the TRP(s) corresponding to the PHR(s) contained in the PHR MAC-CE. In an example implementation, if the TRP bitmap contains multiple active bits (e.g., “1”), the UE 500 may calculate and report multiple PHRs for the TRPs corresponding to the active bits, based on the order of the TRPs and the active bits in the TRP bitmap.

In some of the present implementations, the PHR MAC-CE may include a field of a pathloss reference bitmap to indicate the pathloss reference RS(s) corresponding to the PHR(s) contained in the PHR MAC-CE. In an example implementation, if the pathloss reference bitmap contains multiple active bits (e.g., “1”), the UE 500 may calculate and report multiple PHRs for the pathloss reference RSs indicated by the active bits of the pathloss reference bitmap, based on the order of the pathloss reference RSs and the active bits in the pathloss reference bitmap.

In some of the present implementations, the PHR MAC-CE may include a field of a DMRS port group bitmap to indicate the pathloss reference RS(s) corresponding to the PHR(s) contained in the PHR MAC-CE. In an example implementation, if the DMRS port group bitmap contains multiple active bits (e.g., “1”), the UE 500 may calculate and report multiple PHRs for the DMRS port groups indicated by the active bits of the DMRS port group bitmap, based on the order of the DMRS port groups and the active bits in the DMRS port group bitmap.

In some of the present implementations, the PHR MAC-CE may include a field of a PHR configuration bitmap to indicate the PHR configuration(s) for the PHR(s) contained in the PHR MAC-CE. In an example implementation, each active bit in the PHR configuration bitmap may map to a PHR configuration, based on the order of the PHR configurations and the active bits in the PHR configuration bitmap.

In some of the present implementations, one or more reserved bits in the PHR MAC-CE may be used as any of the above-described fields containing the pathoss-reference-group-related information.

In some of the present implementations, if the number of bits in the PHR MAC-CE for carrying the pathloss-reference-group-related information is less than a certain/predefined number (e.g., no more than two bits), one or more reserved bits of the PHR MAC-CE may be used as any of the above-described fields to represent the pathloss-reference-group-related information. Conversely, if the number of bits in the PHR MAC-CE for carrying the pathloss-reference-group-related information is greater than, or equal to, the certain/predefined number, the PHR MAC-CE may introduce a new field to indicate the pathloss-reference-group-related information. Such a new field may be any of the above-described fields. In an example implementation, the above-mentioned certain/predefined number for determining the MAC-CE format may be various for different PHR formats (e.g., the single-entry PHR format and the multi-entry PHR format).

In some of the present implementations, the PHR MAC-CE applied in the multi-TRP system may have a different LCID than the PHR MAC-CE that is defined in the NR Release-15.

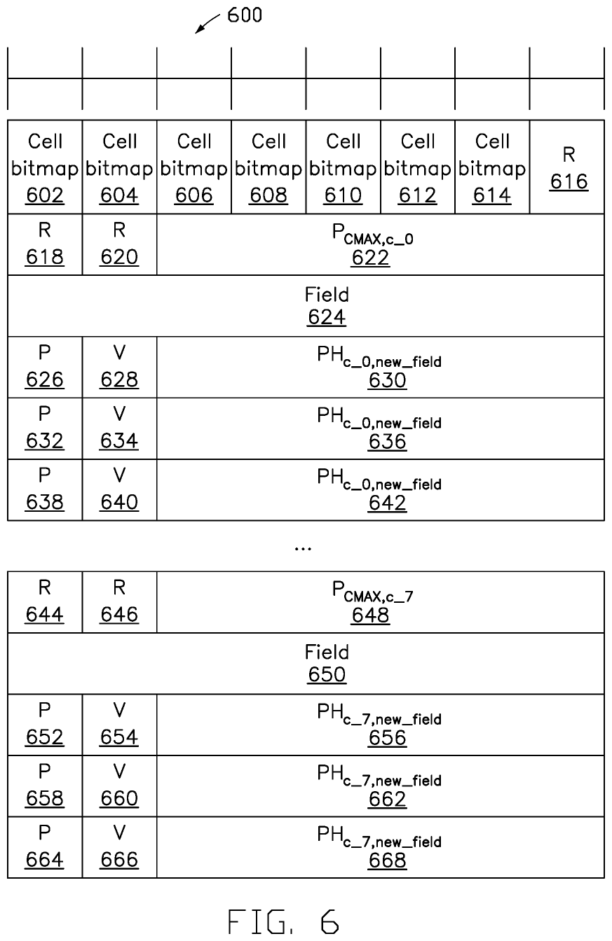

FIG. 6 is a schematic diagram illustrating a format of a MAC-CE 600, in accordance with example implementations of the present disclosure. As shown in FIG. 6, the MAC-CE 600 includes cell bitmap fields 602, 604, 606, 608, 610, 612 and 614, reserved bit fields 616, 618, 620 and 646, power backoff indicators 626, 632, 638, 644, 652, 658 and 664, PHR type indicators 628, 634, 640, 654, 660 and 666, maximum power value fields 622 and 648, power headroom value fields 630, 636, 642, 656, 662 and 668, and new fields 624 and 650. Each of the power backoff indicators 626, 632, 638, 644, 652, 658 and 664 may be used to indicate whether to decrease a corresponding TX power temporarily based on a power management. Each of the PHR type indicators 628, 634, 640, 654, 660 and 666 may be used to indicate the PHR format of a corresponding PHR.

In the example implementation, each of the new fields 624 and 650 may be used as any of the above-described fields for carrying the pathloss-reference-group-related information. The notations “c_0” to “c_7” demonstrated in FIG. 6 may be the cell indices of those cells that are indicated by the cell bitmap fields 602, 604, 606, 608, 610, 612 and 614. The power headroom value fields 630, 636 and 642 may be derived from the maximum power value field 622, and the power headroom value fields 656, 662 and 668 may be derived from the maximum power value field 648. For example, the value of the power headroom value field 630 may be obtained by, but is not limited to, subtracting the value of the actual UE TX power from the value of the maximum power value field 622. It should be noted that the example implementation is not intended to limit the scope of the present application. In some other implementations of the present disclosure, any number of the fields may be included in the MAC-CE, and each field in the MAC-CE may be arranged in a difference order and/or have a different size than the example implementation.

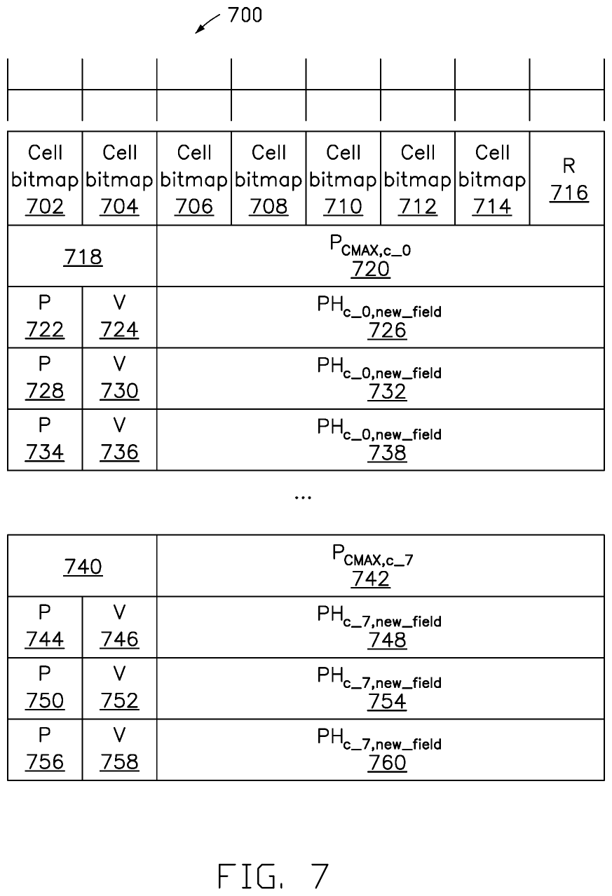

FIG. 7 is a schematic diagram illustrating a format of a MAC-CE 700, in accordance with example implementations of the present disclosure. As shown in FIG. 7, the MAC-CE 700 includes cell bitmap fields 702, 704, 706, 708, 710, 712 and 714, reserved bit fields 716, 718 and 740, power backoff indicators 722, 728, 734, 744, 750 and 756, PHR type indicators 724, 730, 736, 746, 752 and 758, maximum power value fields 720 and 742, power headroom value fields 726, 732, 738, 748, 754 and 760.

The main difference between the example implementations of FIG. 6 and FIG. 7 is that in the example implementation of FIG. 7, the reserved bit fields 718 and 740 are used as the fields for carrying the pathloss-reference-group-related information.

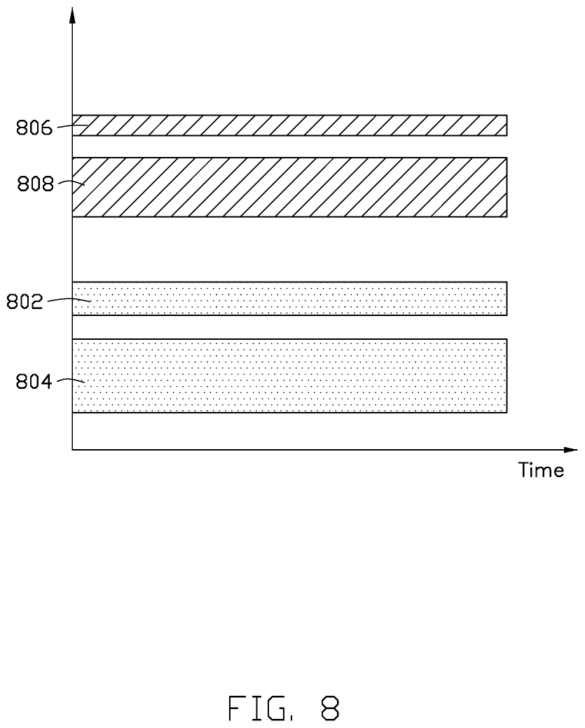

FIG. 8 is a schematic diagram illustrating an operation of multiple active BWPs, in accordance with example implementations of the present disclosure. As shown in FIG. 8, a UP BWP set includes a UL BWP 806 and a UL BWP 808, and a DL BWP set includes a DL BWP 802 and a DL BWP 804. A UE may perform transmissions/receptions via the UL/DL BWPs through the TX/RX circuit based on the signaling between the UE and the BS.

In some of the present implementations, if there are multiple DL BWPs (e.g., the DL BWP 802 and the DL BWP 804) partially overlapping with each other in the frequency domain (e.g., the resource allocations of the DL BWPs 802 and 804 overlap in at least one resource element in the frequency domain), the BS may only transmit one DL RS in the overlapped frequency region. In such a case, even though the overlapped DL BWPs may be associated with different UL BWPs, the UL BWPs (associated with the overlapped DL BWPs) may share with the same pathloss reference RS (e.g., the DL RS used in the overlapped frequency region), and those DL RSs in the overlapped frequency region may belong to the same pathloss reference group.

In some of the present implementations, the BS may transmit a DL signal, an RS #1 and an RS #2 to the UE though the DL BWP 802 in a slot n. The UE may receive the DL signal, the RS #1 and the RS #2 via the RX circuit, and decode the PDCCH that contains the DCI for UL transmissions by the PHY layer. The PDCCH in the DL signal may schedule the UL transmissions allocated in the UL BWP 806 and/or the UL BWP 808. The UE may find that the RS #1 and the RS #2 are the pathloss reference RSs for measuring the pathloss of the UL BWP 806 and the UL BWP 808, respectively. If the pathloss difference between the pathloss measured by the RS #1 and the pathloss measured by the RS #2 is larger than a PHR trigger threshold, the controller of the UE may instruct the MAC layer of the UE to transmit a PHR. It should be noted that the RS #1 for the UL BWP 806 and the RS #2 for the UL BWP 808 may belong to the same pathloss reference group, and the RS #1 and the RS #2 may be the same as the pathloss reference RS for the DL BWP 802. Conversely, if the pathloss reference RS for the UL BWP 806 and the UL BWP 808 belong to different DL BWPs, the controller of the UE may not instruct the MAC layer of the UE to transmit a PHR even when the above-described pathloss difference is larger than the PHR trigger threshold.

In some of the present implementations, if the UL BWPs 806 and 808 have different UL BWP IDs, the controller of the UE may not instruct the MAC layer of the UE to transmit a PHR when the pathloss differences measured by the RS #1 and the RS #2 are larger than the PHR trigger threshold.

In some of the present implementations, when the PHRs for both of the UL BWP 806 and the UL BWP 808 are triggered, the controller of the UE may cancel the PHR triggering operation for the UL BWP 808 (if the UL resource is not enough to allow the UE to transmit the PHRs for both of the UL BWP 806 and the UL BWP 808, and the pathloss difference measured for the UL BWP 806 is larger than that for the UL BWP 808).

In some of the present implementations, the BS may transmit a DL signal #1 and an RS #1 to the UE through the DL BWP 802 in a slot n, and transmit a DL signal #2 and an RS #2 to the UE through the DL BWP 804 in a slot n+k (where k>0). The UE may receive the DL signal #1, the DL signal #2, the RS #1 and the RS #2 by the RX circuit, and decode the PDCCHs that contains the DCI for scheduling the UL transmissions by the PHY layer. For example, a first PDCCH may be transmitted in the DL signal #1 for scheduling a UL transmission associated with the RS #1, and a second PDCCH may be transmitted in the DL signal #2 for scheduling a UL transmission associated with the RS #2. In the example implementation, the UE may know that the RS #1 and the RS #2 are transmitted through different BWPs, and the UE may trigger a PHR that is calculated based on the pathloss measured by the RS #2.

In some of the present implementations, the UE may trigger a PHR when the UE finds that a number of UL transmissions (e.g., triggered by different DCI) to be performed in different UL BWPs.

In some of the present implementations, the UE may trigger a PHR when the UE finds that the DL signal #1 or the DL signal #2 contains a MAC-CE (or RRC signaling) for activating one or more UL BWPs. The active UL BWP(s) (activated by the MAC-CE or the RRC signaling) may be different from the current UL BWP for the UE.

In some of the present implementations, the MAC layer of the UE may maintain a PHR prohibit timer #1 configured for the UL BWP 806 and a PHR prohibit timer #2 configured for the UL BWP 808. In an example implementation, when the MAC layer of the UE receives a UL grant #1 (e.g., containing an SRI, or other QCL information, for a PUSCH that is associated with the RS #1) in the DL signal #1, the MAC layer of the UE may not trigger a PHR if the UE finds that the PHR prohibit timer #1 has not yet expired. Thereafter, the MAC layer of the UE may further receive a UL grant #2 in the DL signal #2. The UL grant #2 may contain an SRI, or other QCL information, for a PUSCH that is associated with the RS #2. If the UE finds that the PHR prohibit timer #2 has expired, the controller of the UE may instruct the MAC layer of the UE to trigger a PHR based on the pathloss measured by a pathloss reference RS (e.g., the RS #2) that is associated with the UL grant #2. In some of the present implementations, the PHR prohibit timer #1 and the PHR prohibit timer #2 may be operated independently of one another. For example, the UE may check only the PHR prohibit timer #2 to determine whether to trigger a PHR if the corresponding pathloss reference RS is associated with the UL BWP 808. In such a case, the MAC layer of the UE may transmit a PHR for the UL BWP 808 when certain condition(s) is satisfied, regardless of the expiration of the PHR prohibit timer #1.

In some of the present implementations, when the RRC layer of the UE receives an RRC reconfiguration for modifying the configuration of a specific UL BWP, the UE may cancel the PHR triggering operation for this specific UL BWP.

In some of the present implementations, the UE may cancel the PHR triggering operation for a specific UL BWP if the MAC layer of the UE receives a MAC-CE for inactivating the specific UL BWP.

In some of the present implementations, the UE may cancel the PHR triggering operation for a specific UL BWP if the PHY layer of the UE receives the DCI for inactivating the specific UL BWP.

In some of the present implementations, the MAC layer of the UE may initiate the PHR triggering operation and transmit a PHR through a PHR MAC-CE to the BS. The PHR MAC-CE may include a field that contains one or more UL BWP indices, for indicating the UL BWP(s) corresponding to the PHR. In some of such implementations, the MAC layer of the UE may calculate a power headroom value according to a pathloss value measured by the pathloss reference RS that is associated with the UL BWP.

In some of the present implementations, the PHR MAC-CE may include a field of a UL BWP bitmap for indicating the UL BWP(s) that corresponds to the PHR(s) contained in the PHR MAC-CE. For example, the UL BWP bitmap may contain several active bits (e.g., “1”), and the MAC layer of the UE may calculate multiple PHRs and report these PHRs for the UL BWPs (indicated by the UL BWP bitmap) based on the order of the UL BWP indices and the active bits in the UL BWP bitmap. For example, as shown in Table 2, the UE may report the PHRs for the UL BWP #2 and the UL BWP #3 based on the mapping relationship between the UL BWPs #0 to #3 and the active bits in the UL BWP bitmap.

TABLE 2

| UL BWP index | #0 | #1 | #2 | #3 |
|---|---|---|---|---|
| Active bit | 0 | 0 | 1 | 1 |

In some of the present implementations, the PHR MAC-CE may contain a cell/BWP indicator for indicating that a specific field in the PHR MAC-CE is either used to represent a serving cell index(s) or used to represent a BWP index(s). For example, when the cell/BWP indicator is set to “0,” the specific field may represent the serving cell index(s), whereas when the cell/BWP indicator is set to “1,” the specific field may represent the UL BWP index(s). In some of the present implementations, such a specific field may contain a number of active bits (e.g., “1”), with each active bit being corresponding to a UL BWP or a serving cell. The MAC layer of the UE may calculate one or more PHRs for the UL BWP(s) (or serving cell(s), depending on the value of the cell/BWP indicator) corresponding to the active bits, based on the order of the UL BWP indices (or the serving cell indices) and the active bits in the bitmap. In some of the present implementations, if the cell/BWP indicator is set to “0,” the UE may only report the PHR for the serving cell on which this PHR is transmitted. Conversely, if the cell/BWP indicator is set to “1,” the UE may report the PHR(s) for all active UL BWPs in the active serving cell(s). It should be noted the bit value (e.g., “0” or “1”) assigned to each case of the cell/BWP indicator above are for illustration purpose only, and can be reassigned.

In some of the present implementations, one or more reserved bits in the PHR MAC-CE may be used to represent at least part of the cell/BWP-related information (e.g., the UL BWP index(s), the UL BWP bitmap(s), or the cell/BWP indicator(s)). For example, if the number of the active UL BWPs is less than a certain/predefined number (e.g., less than two), the reserved bit(s) in the PHR MAC-CE may be used to represent at least part of the cell/BWP-related information. Otherwise, the PHR MAC-CE may introduce a new field (other than the reserved bit fields) to indicate the cell/BWP-related information. In some of the present implementations, the above-described certain value for determining the MAC-CE format may be various for different PHR formats (e.g., the single-entry PHR format or the multi-entry PHR format).

In some of the present implementations, the PHR MAC-CE applied in the multi-active-BWP system may have a different LCID than the PHR MAC-CE defined in NR Release-15.

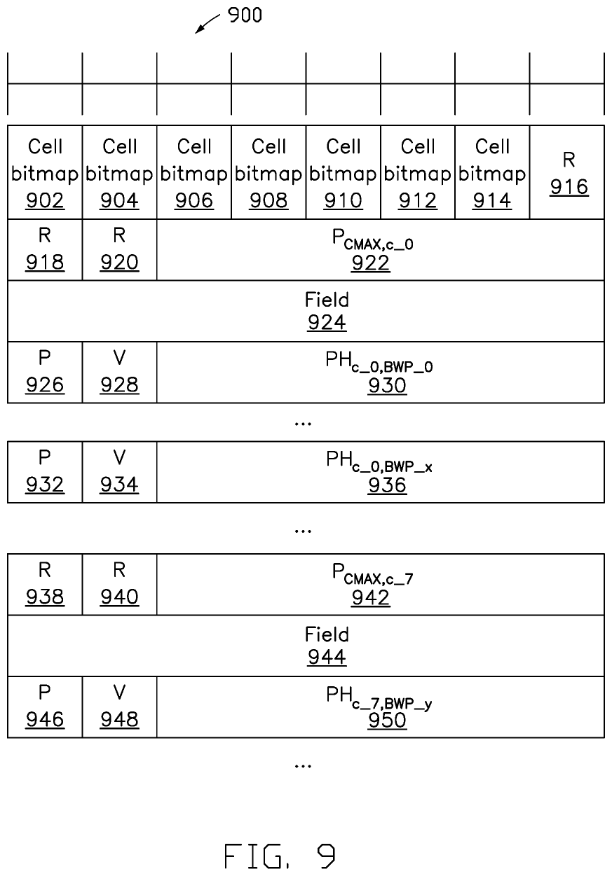

FIG. 9 is a schematic diagram illustrating a format of a MAC-CE 900, in accordance with example implementations of the present disclosure. As shown in FIG. 9, the MAC-CE 900 includes cell bitmap fields 902, 904, 906, 908, 910, 912 and 914, reserved bit fields 916, 918, 920, 938 and 940, power backoff indicators 926, 932, 938 and 946, PHR type indicators 928, 934 and 948, maximum power value fields 922 and 942, power headroom value fields 930, 936 and 950, and new fields 924 and 944.

In the example implementation, each of the new field 924 and the new field 944 may be used as any of the above-described field for carrying the cell/BWP-related information (e.g., the UL BWP index(s), the UL BWP bitmap(s), or the cell/BWP indicator(s)). The notations “c_0” to “c_7” may be the cell indices of those cells (e.g., the SPCells) that are indicated by the cell bitmap fields 902, 904, 906, 908, 910, 912 and 914. The notations “BWP_0” and “BWP_x” in the power headroom value fields 930 and 936 may be the BWP indices indicated by the new field 924. The notation “BWP_y” in the power headroom value field 950 may be the BWP index indicated in the new field 944. In addition, the power headroom value fields 930 and 936 may be derived from the maximum power value field 922, and the power headroom value field 950 may be derived from the maximum power value field 942.

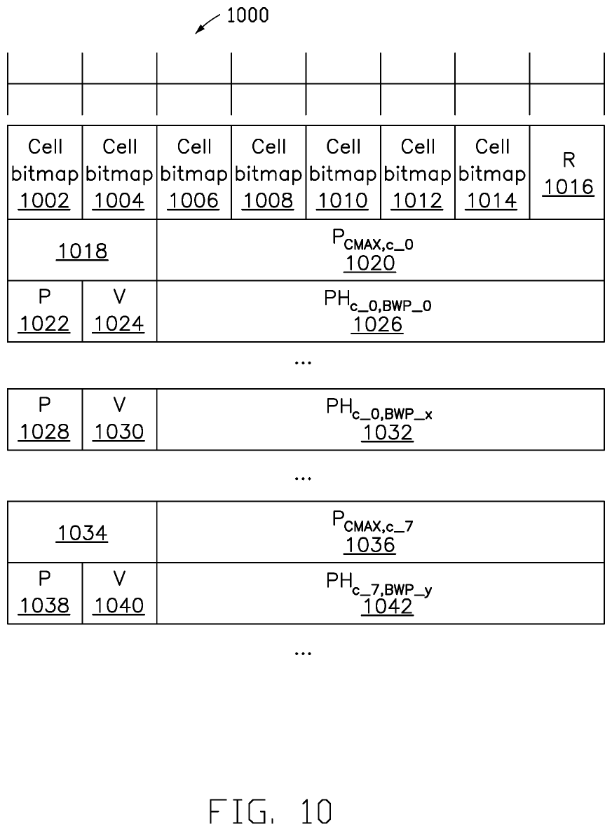

FIG. 10 is a schematic diagram illustrating a format of a MAC-CE 1000, in accordance with example implementations of the present disclosure. As shown in FIG. 10, the MAC-CE 1000 includes cell bitmap fields 1002, 1004, 1006, 1008, 1010, 1012 and 1014, reserved bit fields 1016, 1018 and 1034, power backoff indicators 1022, 1028 and 1038, PHR type indicators 1024, 1030 and 1040, maximum power value fields 1020 and 1036, power headroom value fields 1026, 1032 and 1042.

The main difference between the example implementations of FIG. 9 and FIG. 10 is that in the example implementation of FIG. 10, the reserved bit fields 1018 and 1034 are used as the fields for carrying the cell/BWP-related information.

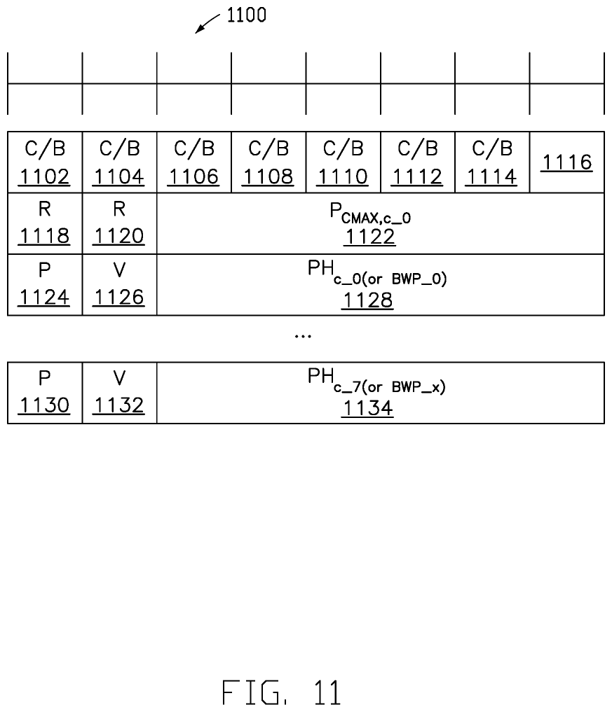

FIG. 11 is a schematic diagram illustrating a format of a MAC-CE 1100, in accordance with example implementations of the present disclosure. As shown in FIG. 11, the MAC-CE 1100 includes C/B fields 1102, 1104, 1106, 1108, 1110, 1112 and 1114, a cell/BWP indicator field 1116, reserved bit fields 1118 and 1120, power backoff indicators 1124 and 1130, PHR type indicators 1126 and 1132, a maximum power value field 1122, and power headroom value fields 1128 and 1134.

In the example implementation, the cell/BWP indicator field 1116 may be set to “1” or “0” to indicate that the C/B fields 1102, 1104, 1106, 1108, 1110, 1112 and 1114 are used to represent cell indices or BWP indices. For example, if the cell/BWP indicator field 1116 is set to “0,” each of the C/B fields 1102, 1104, 1106, 1108, 1110, 1112 and 1114 may correspond to a cell. In such a case, the notations “c_0” to “c_7” in the power headroom value fields may be the cell indices of those cells that are indicated by the C/B fields 1102, 1104, 1106, 1108, 1110, 1112 and 1114. Conversely, if the cell/BWP indicator field 1116 is set to “1,” each of the C/B fields 1102, 1104, 1106, 1108, 1110, 1112 and 1114 may correspond to a BWP. In such a case, the notations “BWP_0” and “BWP_x” in the power headroom value fields may be the BWP indices indicated by the C/B fields 1102, 1104, 1106, 1108, 1110, 1112 and 1114.

It should be noted that the various MAC-CE formats described herein are not intended to limit the scope of the present application. In some other implementations of the present disclosure, any number of the fields may be included in the MAC-CE, and each field in the MAC-CE may be arranged in a difference order and/or has a different size than the example implementations.

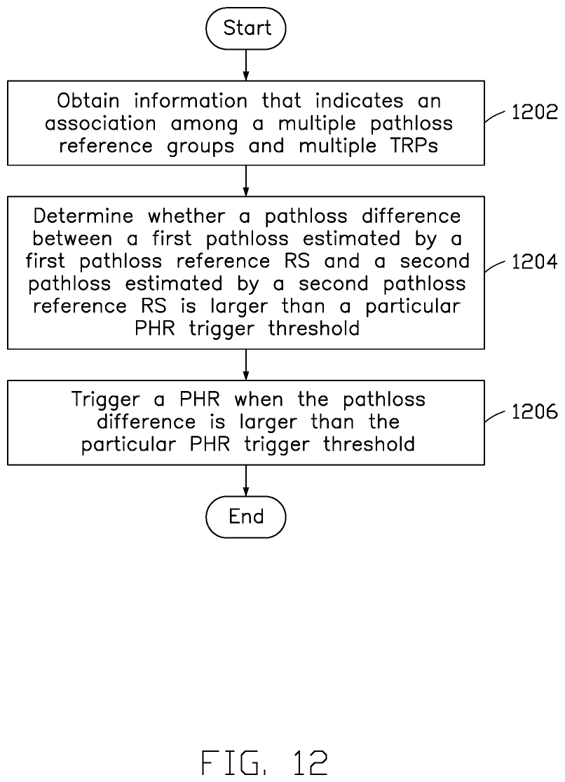

FIG. 12 is a flowchart of a method for triggering a PHR in a multi-TRP system, in accordance with example implementations of the present disclosure. In action 1202, a UE may obtain information that indicates an association among multiple pathloss reference groups and multiple TRPs.

In action 1204, the UE may determine whether a pathloss difference between a first pathloss (estimated by a first pathloss reference RS) and a second pathloss (estimated by a second pathloss reference RS) is larger than a particular PHR trigger threshold. The first pathloss reference RS may be the same as, or different than, the second pathloss reference RS. In some of the present implementations, the first pathloss reference RS and the second pathloss reference RS may belong to a particular pathloss reference group of the multiple pathloss reference groups.

In action 1206, the UE may trigger a PHR when the pathloss difference is larger than the particular PHR trigger threshold. In some of the present implementations, the PHR may indicate a power headroom value for an SRS, a PUCCH or a PUSCH.

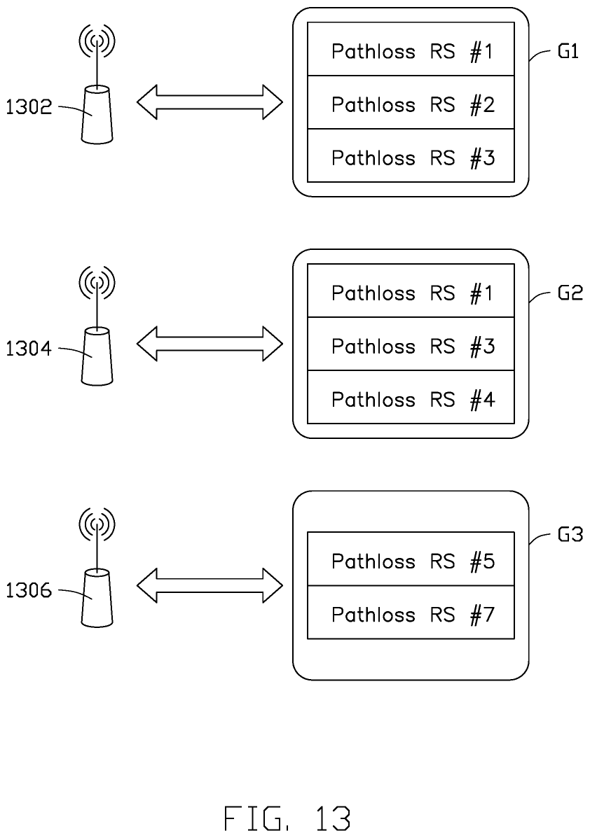

FIG. 13 is a schematic diagram illustrating multiple TRPs each being associated with a pathloss reference group, in accordance with example implementations of the present disclosure. In the example implementation, the pathloss reference groups and the TRPs may have a one-to-one mapping relationship. As shown in FIG. 13, the TRP 1302, the TRP 1304, and the TRP 1306 are associated with the pathloss reference group G1, the pathloss reference group G2, and the pathloss reference group G3, respectively. The association (or the one-to-one mapping relationship) between the TRPs 1302, 1304 and 1306 and the pathloss reference groups G1, G2 and G3 may be configured by the network (e.g., configured by a BS), or preconfigured in the terminal device (e.g., in the UE).

In the example implementation, each pathloss reference group may be configured independently of one another. As shown in FIG. 13, the pathloss reference group G1 includes a pathloss reference RS #1, a pathloss reference RS #2 and a pathloss reference RS #3, the pathloss reference group G2 includes a pathloss reference RS #1, a pathloss reference RS #3 and a pathloss reference RS #4, and the pathloss reference group G3 includes a pathloss reference RS #5 and a pathloss reference RS #7. It should be noted that in some other of the present implementations, any number or type of the pathloss reference RSs may be included in each pathloss reference group.

In some of the present implementations, the UE may receive PHR configurations of the pathloss reference groups (e.g., the PHR configurations of the pathloss reference groups G1, G2 and G3) from the BS. The PHR configurations and the pathloss reference groups may have a one-to-one mapping relationship. In addition, each of the PHR configurations may include at least one of a PHR prohibit timer and a PHR trigger threshold.

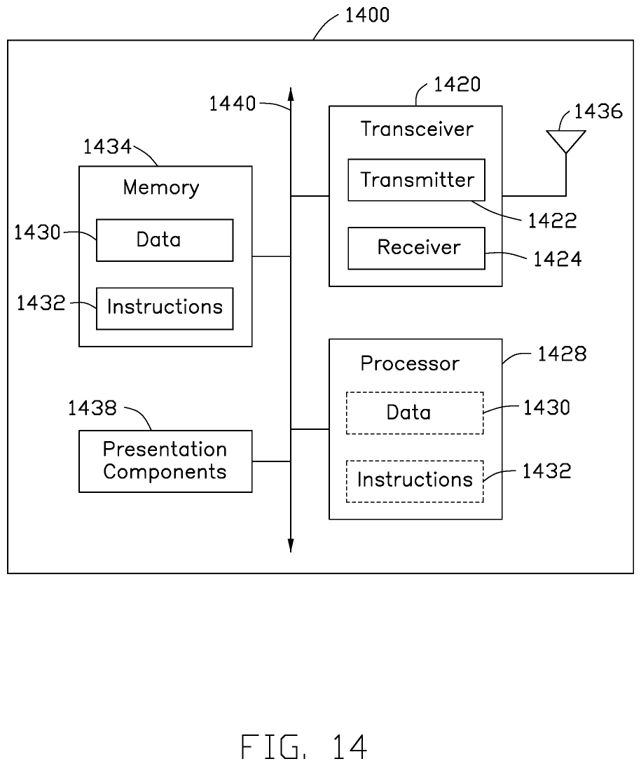

FIG. 14 is a block diagram illustrating a node for wireless communications, in accordance with various aspects of the present application. As shown in FIG. 14, a node 1400 may include a transceiver 1420, a processor 1428, a memory 1434, one or more presentation components 1438, and at least one antenna 1436. The node 1400 may also include an RF spectrum band module, a BS communications module, a network communications module, and a system communications management module, Input/Output (I/O) ports, I/O components, and power supply (not explicitly shown in FIG. 14). Each of these components may be in communication with each other, directly or indirectly, over one or more buses 1440. In one implementation, the node 1400 may be a UE or a BS that performs various functions described herein, for example, with reference to FIGS. 1 through 13.

The transceiver 1420 having a transmitter 1422 (e.g., transmitting/transmission circuitry) and a receiver 1424 (e.g., receiving/reception circuitry) may be configured to transmit and/or receive time and/or frequency resource partitioning information. In some implementations, the transceiver 1420 may be configured to transmit in different types of subframes and slots including, but not limited to, usable, non-usable and flexibly usable subframes and slot formats. The transceiver 1420 may be configured to receive data and control channels.

The node 1400 may include a variety of computer-readable media. Computer-readable media may be any available media that may be accessed by the node 1400 and include both volatile and non-volatile media, removable and non-removable media. By way of example, and not limitation, computer-readable media may comprise computer storage media and communication media. Computer storage media includes both volatile and non-volatile, removable and non-removable media implemented in any method or technology for storage of information such as computer-readable instructions, data structures, program modules or data.

Computer storage media includes RAM, ROM, EEPROM, flash memory or other memory technology, CD-ROM, Digital Versatile Disks (DVD) or other optical disk storage, magnetic cassettes, magnetic tape, magnetic disk storage or other magnetic storage devices. Computer storage media does not comprise a propagated data signal. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The memory 1434 may include computer-storage media in the form of volatile and/or non-volatile memory. The memory 1434 may be removable, non-removable, or a combination thereof. Example memory includes solid-state memory, hard drives, optical-disc drives, and etc. As illustrated in FIG. 14, The memory 1434 may store computer-readable, computer-executable instructions 1432 (e.g., software codes) that are configured to, when executed, cause the processor 1428 to perform various functions described herein, for example, with reference to FIGS. 1 through 13. Alternatively, the instructions 1432 may not be directly executable by the processor 1428 but be configured to cause the node 1400 (e.g., when compiled and executed) to perform various functions described herein.

The processor 1428 (e.g., having processing circuitry) may include an intelligent hardware device, e.g., a Central Processing Unit (CPU), a microcontroller, an ASIC, and etc. The processor 1428 may include memory. The processor 1428 may process the data 1430 and the instructions 1432 received from the memory 1434, and information through the transceiver 1420, the base band communications module, and/or the network communications module. The processor 1428 may also process information to be sent to the transceiver 1420 for transmission through the antenna 1436, to the network communications module for transmission to a core network.

One or more presentation components 1438 presents data indicators to a person or other device. Examples of the presentation components 1438 may include a display device, speaker, printing component, vibrating component, etc.

From the above description, it is manifested that various techniques may be used for implementing the concepts described in the present application without departing from the scope of those concepts. Moreover, while the concepts have been described with specific reference to certain implementations, a person of ordinary skill in the art may recognize that changes may be made in form and detail without departing from the scope of those concepts. As such, the described implementations are to be considered in all respects as illustrative and not restrictive. It should also be understood that the present application is not limited to the particular implementations described above, but many rearrangements, modifications, and substitutions are possible without departing from the scope of the present disclosure.

What is claimed is:

1. A user equipment (UE) comprising:
one or more non-transitory computer-readable media having computer-executable instructions embodied thereon; and
at least one processor coupled to the one or more non-transitory computer-readable media, and configured to execute the computer-executable instructions to:
obtain information that indicates an association among a plurality of pathloss reference groups and a plurality of Transmission and Reception Points (TRPs);
determine whether a pathloss difference between a first pathloss estimated by a first pathloss reference Reference Signal (RS) and a second pathloss estimated by a second pathloss reference RS is larger than a Power Headroom Report (PHR) trigger threshold, wherein the first pathloss reference RS and the second pathloss reference RS belong to a pathloss reference group of the plurality of pathloss reference groups; and
trigger a first PHR when the pathloss difference is larger than the PHR trigger threshold.

2. The UE of claim 1, wherein the at least one processor is further configured to execute the computer-executable instructions to:
trigger a second PHR when the UE is configured with a new TRP by a base station.

3. The UE of claim 2, wherein the UE is configured with the new TRP when the UE receives an activation indicator from the base station, and the activation indicator includes at least one of:
a first Transmission Configuration Indicator (TCI) state for a Physical Downlink Control Channel (PDCCH) associated with the new TRP;
a second TCI state for a Physical Downlink Shared Channel (PDSCH) associated with the new TRP;
a Sounding Reference Signal Resource Index (SRI) of a Physical Uplink Shared Channel (PUSCH) associated with the new TRP;
a Channel State Information Reference Signal (CSI-RS) associated with the new TRP; and
a Synchronization Signal Block (SSB) associated with the new TRP.

4. The UE of claim 2, wherein the UE is configured with the new TRP when the UE receives a configuration of the new TRP through Radio Resource Control (RRC) signaling from the base station, and the configuration of the new TRP includes at least one of:
a first TCI state for a PDCCH associated with the new TRP;
a second TCI state for a PDSCH associated with the new TRP;
a CSI-RS configuration associated with first spatial domain filter information for the new TRP;
a Sounding Reference Signal (SRS) configuration associated with second spatial domain filter information for the new TRP; and
a Physical Uplink Control Channel (PUCCH) configuration associated with the second spatial domain filter information for the new TRP.

5. The UE of claim 1, wherein a pathloss reference group of the plurality of pathloss reference groups comprises at least one pathloss reference RS, and the at least one pathloss reference RS is associated with spatial domain filter information that is configured for a Control Resource Set (CORESET) indicated by a PDCCH configuration.

6. The UE of claim 1, wherein a pathloss reference group of the plurality of pathloss reference groups comprises at least one pathloss reference RS, and the at least one pathloss reference RS is associated with a Demodulation Reference Signal (DMRS) port group.

7. The UE of claim 1, wherein a pathloss reference group of the plurality of pathloss reference groups comprises at least one pathloss reference RS, and the at least one pathloss reference RS is selected from an intersection of a first RS set and a second RS set,
wherein the first RS set includes all RSs associated with a TRP corresponding to the pathloss reference group, and
the second RS set includes a plurality of configured pathloss reference RSs of one of a PUSCH, a PUCCH, and a Sounding Reference Signal (SRS).

8. The UE of claim 1, wherein the first PHR is reported in a Medium Access Control (MAC)-Control Element (CE) which includes at least one of:
a pathloss reference group index of the particular pathloss reference group;
a first pathloss reference index of the first pathloss reference RS;
a second pathloss reference index of the second pathloss reference RS; and
a TRP index.

9. The UE of claim 1, wherein the first PHR is reported in a MAC-CE which includes a bitmap, and each bit in the bitmap represents at least one of:
a pathloss reference group index of the particular pathloss reference group;
a first pathloss reference index of the first pathloss reference RS;
a second pathloss reference index of the second pathloss reference RS; and
a TRP index.

10. The UE of claim 1, wherein the at least one processor is further configured to execute the computer-executable instructions to:
receive a plurality of PHR configurations from a base station, wherein the plurality of PHR configurations and the plurality of pathloss reference groups have a one-to-one mapping relationship, and each of the plurality of PHR configurations comprises at least one of a PHR prohibit timer and the PHR trigger threshold.

11. The UE of claim 1, wherein the plurality of pathloss reference groups and the plurality of TRPs have a one-to-one mapping relationship.

12. The UE of claim 1, wherein the first PHR indicates a power headroom value for one of a Sounding Reference Signal (SRS), a PUCCH and a PUSCH.

13. A method of wireless communications, the method comprising:
obtaining, by a user equipment (UE), information that indicates an association among a plurality of pathloss reference groups and a plurality of Transmission and Reception Points (TRPs);
determining, by the UE, whether a pathloss difference between a first pathloss estimated by a first pathloss reference Reference Signal (RS) and a second pathloss estimated by a second pathloss reference RS is larger than a Power Headroom Report (PHR) trigger threshold, wherein the first pathloss reference RS and the second pathloss reference RS belong to a particular pathloss reference group of the plurality of pathloss reference groups; and
triggering, by the UE, a first PHR when the pathloss difference is larger than the PHR trigger threshold.

14. The method of claim 13, further comprising:
triggering, by the UE, a second PHR when the UE is configured with a new TRP by a base station.

15. The method of claim 14, wherein the UE is configured with the new TRP when the UE receives an activation indicator from the base station, and the activation indicator includes at least one of:
a first Transmission Configuration Indicator (TCI) state for a Physical Downlink Control Channel (PDCCH) associated with the new TRP;
a second TCI state for a Physical Downlink Shared Channel (PDSCH) associated with the new TRP;
a Sounding Reference Signal Resource Index (SRI) of a Physical Uplink Shared Channel (PUSCH) associated with the new TRP;
a Channel State Information Reference Signal (CSI-RS) associated with the new TRP; and
a Synchronization Signal Block (SSB) associated with the new TRP.

16. The method of claim 14, wherein the UE is configured with the new TRP when the UE receives a configuration of the new TRP through Radio Resource Control (RRC) signaling from the base station, and the configuration of the new TRP includes at least one of:
a first TCI state for a PDCCH associated with the new TRP;
a second TCI state for a PDSCH associated with the new TRP;
a CSI-RS configuration associated with first spatial domain filter information for the new TRP;
a Sounding Reference Signal (SRS) configuration associated with second spatial domain filter information for the new TRP; and
a Physical Uplink Control Channel (PUCCH) configuration associated with the second spatial domain filter information for the new TRP.

17. The method of claim 13, wherein a pathloss reference group of the plurality of pathloss reference groups comprises at least one pathloss reference RS, and the at least one pathloss reference RS is associated with spatial domain filter information that is configured for a Control Resource Set (CORESET) indicated by a PDCCH configuration.

18. The method of claim 13, wherein a pathloss reference group of the plurality of pathloss reference groups comprises at least one pathloss reference RS, and the at least one pathloss reference RS is associated with a Demodulation Reference Signal (DMRS) port group.

19. The method of claim 13, wherein a pathloss reference group of the plurality of pathloss reference groups comprises at least one pathloss reference RS, and the at least one pathloss reference RS is selected from an intersection of a first RS set and a second RS set,
wherein the first RS set includes all RSs associated with a TRP corresponding to the pathloss reference group, and
the second RS set includes a plurality of configured pathloss reference RSs of one of a PUSCH, a PUCCH, and a Sounding Reference Signal (SRS).

20. The method of claim 13, wherein the first PHR is reported in a Medium Access Control (MAC)-Control Element (CE) which includes at least one of:
a pathloss reference group index of the particular pathloss reference group;
a first pathloss reference index of the first pathloss reference RS;
a second pathloss reference index of the second pathloss reference RS; and
a TRP index.

21. The method of claim 13, wherein the first PHR is reported in a MAC-CE which includes a bitmap, and each bit in the bitmap represents at least one of:
a pathloss reference group index of the particular pathloss reference group;
a first pathloss reference index of the first pathloss reference RS;
a second pathloss reference index of the second pathloss reference RS; and
a TRP index.

22. The method of claim 13, further comprising:
receiving, by the UE, a plurality of PHR configurations from a base station, wherein the plurality of PHR configurations and the plurality of pathloss reference groups have a one-to-one mapping relationship, and each of the plurality of PHR configurations comprises at least one of a PHR prohibit timer and the PHR trigger threshold.

23. The method of claim 13, wherein the plurality of pathloss reference groups and the plurality of TRPs have a one-to-one mapping relationship.

24. The method of claim 13, wherein the first PHR indicates a power headroom value for one of a Sounding Reference Signal (SRS), a PUCCH and a PUSCH.
